(19) United States
(12) Patent Application Publication
(10) Pub. No.: US 2014/0334364 A1
(43) Pub. Date: Nov. 13, 2014

(54) REMOTE WAKE-UP SYSTEM AND METHOD

(71) Applicant: Wistron Corp., New Taipei City (TW)

(72) Inventor: Kuan Lin LIU, New Taipei City (TW)

(73) Assignee: Wistron Corp., New Taipei City (TW)

(21) Appl. No.: 14/214,226

(22) Filed: Mar. 14, 2014

(30) Foreign Application Priority Data
May 13, 2013 (TW) 102116837

(51) Int. Cl. H04W 52/02

(52) U.S. Cl. CPC H04W 52/0206
USPC 370/311

(57) ABSTRACT

A remote wake-up system and method are provided. The system includes an electrical device; a remote device, having a network card which includes a first wireless transmission module and the remote device is in a soft-off state; and a wireless routing device, having a second wireless transmission module and having established a pair with the first wireless transmission module by the second wireless transmission module and generated a device name and stored the device name in the wireless routing device. The electrical device generates a selection result by selecting the device name after the electrical device registers the wireless routing device, and the wireless routing device transmits a wake-up signal to the first wireless transmission module by the second wireless transmission module according to the selection result. Then the first wireless transmission module generates a trigger signal for switching the remote device to a boot state.

### CROSS REFERENCE TO RELATED APPLICATIONS

This Application claims priority of Taiwan Patent Application No. 102116837, filed on May 13, 2013, the entirety of which is incorporated by reference herein.

### BACKGROUND OF THE DISCLOSURE

1. Field of the Disclosure

The disclosure generally relates to remote wake-up technology, and more particularly to technology that wakes a remote device from a soft-off state by integrating a short-distance transmission function.

2. Description of the Related Art

Wake-on-LAN (WOL) technology is used to command a computer which is in a sleep state or a soft-off state by another computer in the local area network (LAN) for waking the computer up from the sleep state, recovering it to an on state, or making it transition from the soft-off state to a boot state. In addition, the WOL technology further comprises the other related operation mechanisms such as commands to shut down or to turn on the computer from the remote end.

When the computer is in the soft-off (or sleep) state, the network card and partial main board of the computer still have weak power to allow the network card to maintain a minimum operational capability for receiving external broadcast information and detecting and analyzing the broadcast information. When the specific information is detected from the broadcast information, a Magic Packet may be transmitted to the computer which needs to wake. When the computer is in the soft-off state, the network card supporting the WOL technology may process the Magic Packet mode and when the magic packet is received, the signal is transmitted to the mainboard for turning on the computer by the network card.

Traditional remote wake-up technology is applied in a wired network environment, and in the traditional remote wake-up technology, the host computer transmits the magic packets by the network line. However, along with the evolution of network technology, which is advancing daily, users often use WiFi at home so that their computers do not have to be put in the same place all the time and so that there are not so many network wires at home. However, in a wireless environment, the traditional remote wake-up technology may not wake the computer from a soft-off state (S5 state) as defined in the Advanced Configuration and Power Interface (ACPI).

### BRIEF SUMMARY OF THE DISCLOSURE

Remote wake-up apparatus and methods for waking a remote device from a soft-off state by integrating a short-distance transmission function are provided to overcome the aforementioned problems.

An embodiment of the disclosure provides a remote wake-up system for Wake-On-LAN (WOL) technology, comprising an electrical device, a remote device, and a wireless routing device. The remote device is in a soft-off state. The remote device includes a network card, which includes a first wireless transmission module. The wireless routing device is configured to include a second wireless transmission module. The wireless routing device is configured to establish a pair with the first wireless transmission module by the second wireless transmission module and generate a device name and store the device name in the wireless routing device. The electrical device generates a selection result by a user selecting the device name corresponding to the remote device after the electrical device registers the wireless routing device. The wireless routing device transmits a wake-up signal to the first wireless transmission module by the second wireless transmission module according to the selection result. The first wireless transmission module generates a trigger signal for switching the remote device from the soft-off state to a boot state after receiving the wake-up signal.

An embodiment of the disclosure provides a remote wake-up method for Wake-On-LAN (WOL) technology, comprising: establishing a pair between a remote device and a wireless routing device for generating a device name and storing the device name in the wireless routing device; selecting a device name corresponding to the remote device and generating a selection result after an electrical device registers the wireless routing device; transmitting a wake-up signal to the remote device by the wireless routing device according to the selection result; and receiving the wake-up signal by the remote device for switching the remote device from a soft-off state to a boot state.

Other aspects and features of the disclosure will become apparent to those with ordinary skill in the art upon review of the following descriptions of specific embodiments of communication transmission methods and systems.

### BRIEF DESCRIPTION OF THE DRAWINGS

The disclosure will become more fully understood by referring to the following detailed description with reference to the accompanying drawings, wherein:

FIG. 1 is a block diagram of a remote wake-up system 100 according to an embodiment of the disclosure;

FIG. 2A is a block diagram of a network card 112 according to an embodiment of the disclosure;

FIG. 2B is a block diagram of a network card 112 according to another embodiment of the disclosure;

FIG. 3 is a flow chart 300 illustrating a remote wake-up method according to an embodiment of the disclosure.

### DETAILED DESCRIPTION OF THE DISCLOSURE

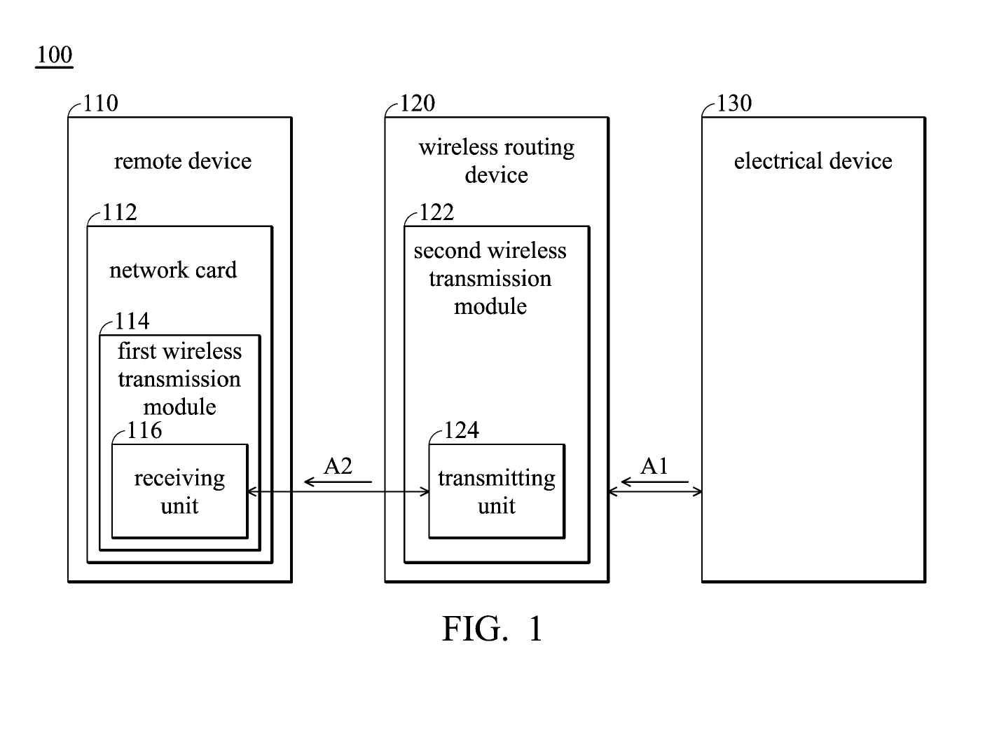

FIG. 1 is a block diagram of a remote wake-up system 100 according to an embodiment of the disclosure, wherein the remote wake-up system 100 is applied to Wake-on-LAN (WOL) technology. As shown in FIG. 1, the remote wake-up system 100 includes a remote device 110, a wireless routing device 120, and an electrical device 130. In an embodiment of the disclosure, the remote device 110 is a Personal Digital Assistant (PDA), a laptop computer, a desktop computer, a smartphone, a mobile phone, etc. In an embodiment of the disclosure, the wireless routing device 120 may be an access point (AP). In an embodiment of the disclosure, the electrical device 130 also may be a Personal Digital Assistant, a laptop computer, a desktop computer, a smartphone or a mobile phone, etc.

In an embodiment of the disclosure, the remote device 110 has a network card 112, and the remote device 110 is in a soft-off state, wherein the network card 112 comprises a first wireless transmission module 114. Note that the soft-off state in the embodiment is the S5 state which is defined in the Advanced Configuration and Power Interface (ACPI).

In an embodiment of the disclosure, the wireless routing device 120 comprises a second wireless transmission module 122. The wireless routing device 120 has established a pair with the first wireless transmission module 114 by the second wireless transmission module 122 and generates a device name and stores the device name in the wireless routing device 120. That is to say, before processing the remote wake-up operation, the wireless routing device 120 needs to have established a pair with the remote device 110. For example, the wireless routing device 120 establishes a pair by Bluetooth transmission or another short-distance transmission scheme. In an embodiment of the disclosure, the first wireless transmission module 114 and the second wireless transmission module 122 are Bluetooth transmission modules, and they process the transmission according to the Bluetooth profile, but the disclosure is not limited thereto. The first wireless transmission module 114 and the second wireless transmission module 122 may adopt the ZigBee specification as defined in IEEE 802.15.4, Radio Frequency Identification (RFID), or another wireless transmission standard. The first wireless transmission module 114 comprises a receiving unit 116, and the second wireless transmission module 122 comprises a transmitting unit 124. The remote device 110 and wireless routing device 120 may establish a pair by the receiving unit 116 and the transmitting unit 124, and the device name corresponding to the remote device 110 and related information are stored in the wireless routing device 120.

In an embodiment of the disclosure, an interface is generated after the electrical device 130 has registered the wireless routing device 120. The user may select the device name corresponding to the desired remote device 110 by the interface for generating a selection result A1. The wireless routing device 120 transmits a wake-up signal A2 to the receiving unit 116 of the first wireless transmission module 114 by the transmitting unit 124 of the second wireless transmission module 122 according to the selection result A1. After the receiving unit 116 of the first wireless transmission module 114 receives the wake-up signal A2, a trigger signal A3 (not present in FIG. 1) is generated, and the remote device 110 is switched from the soft-off state to a boot state.

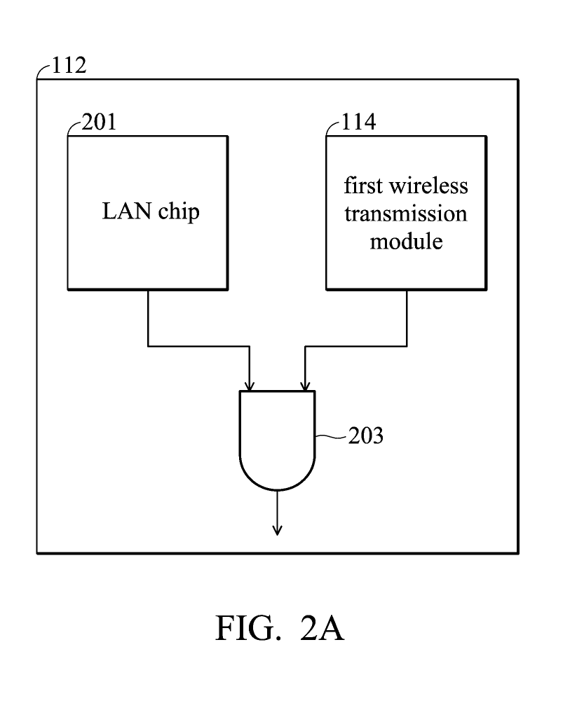

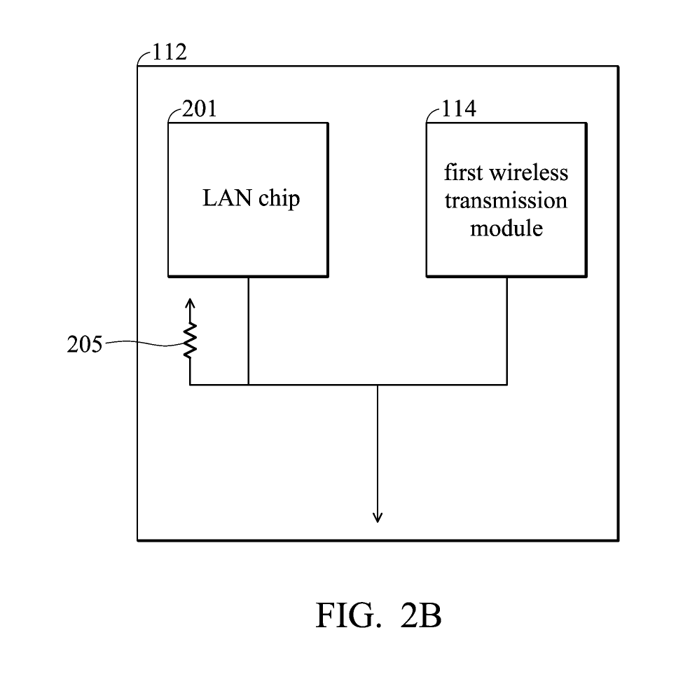

FIG. 2A is a block diagram of a network card 112 according to an embodiment of the disclosure. As shown in FIG. 2A, the network card 112 further comprises a LAN chip 201 and logic gate (AND gate) 203, and the logic gate 203 is connected with the first wireless transmission module 114 and the LAN chip 201. In traditional Wake-on-LAN (WOL) technology, the network card 112 may wake the remote device 110 from a sleep state by the LAN chip 201, wherein the sleep state is an S3 or S4 state as defined in the ACPI. Therefore, the network card 112 may integrate the remote wake-up scheme corresponding to the S3 and S4 states (using the LAN chip 201) and the remote wake-up scheme corresponding to S5 (using the first wireless transmission module 114) by the AND gate 203 (only when the output of the AND gate 203 is 0, indicating that the remote device 110 is in a boot state). FIG. 2B is a block diagram of a network card 112 according to another embodiment of the disclosure. As shown in FIG. 2B, the network card 112 further comprises a LAN chip 201 and a resistor 205. The operating principle of the resistor 205 is similar to that of the AND gate 203 which is shown in FIG. 2A. The network card 112 may detect whether a signal is output from the LAN chip 201 and the first wireless transmission module 114 by the resistor 205. Only when a signal is output from the LAN chip 201 or the first wireless transmission module 114, it is indicated that the remote device 110 is in the boot state. That is to say, if a signal is output from the LAN chip 201 or the first wireless transmission module 114, it is indicated as the logic level is set to 0, and if no signal is output from the LAN chip 201 or the first wireless transmission module 114, it is indicated as the logic level is set to 1. Therefore, as with AND gate 203, when a signal is output from the LAN chip 201 or the first wireless transmission module 114, it is indicated that the remote device 110 is in a boot state. Therefore, the network card 112 may integrate the remote wake-up scheme corresponding to the S3 and S4 states (using the LAN chip 201) and the remote wake-up scheme corresponding to S5 (using the first wireless transmission module 114) by the resistor 205.

In an embodiment of the disclosure, after the wireless routing device 120 transmits the wake-up signal A2 to the remote device 110, the wireless routing device 120 may detect whether the remote device 110 has switched to a boot state. If the remote device 110 has not switched to a boot state, the wireless routing device 120 may transmit the wake-up signal A2 to the remote device 110 again after a preset time interval. For example, if the wireless routing device 120 detects that the remote device 110 has not switched to a boot state, the wireless routing device 120 may wait 5 sec or 10 sec and then transmit the wake-up signal A2 to the remote device 110 again. In addition, the number of retransmissions of the wake-up signal A2 may be set by the user, such as 3 or 5.

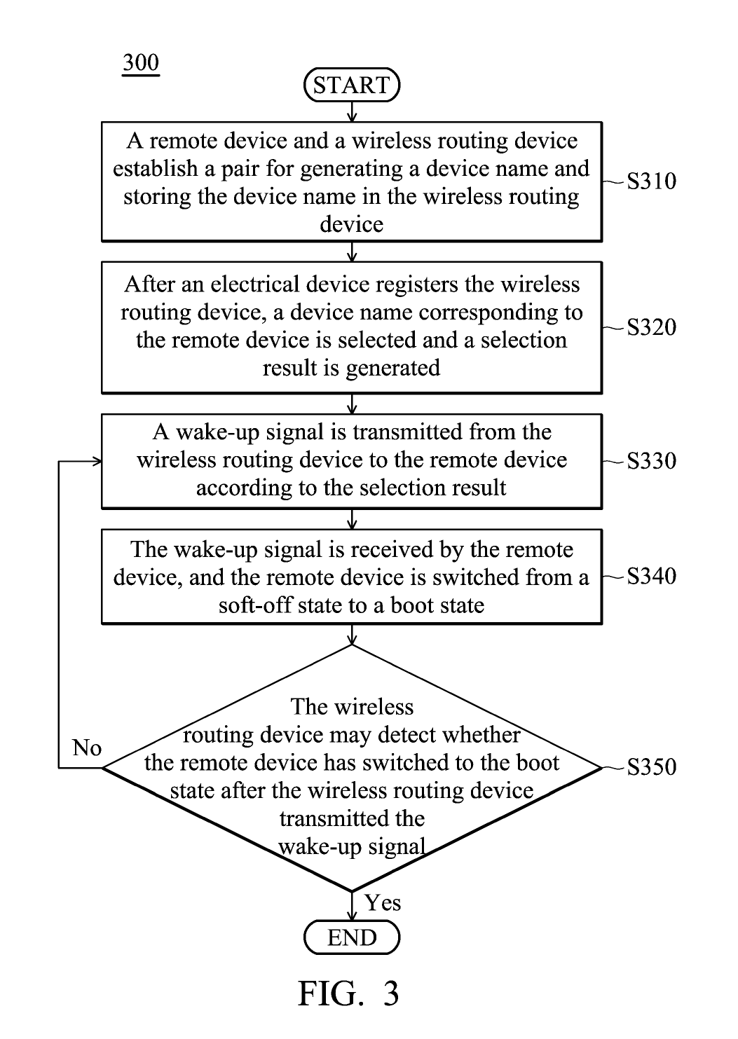

FIG. 3 is a flow chart 300 illustrating a remote wake-up method according to an embodiment of the disclosure, wherein the remote wake-up method is applied to Wake-on-LAN (WOL) technology. Firstly, in step S310, a remote device and a wireless routing device establish a pair for generating a device name and storing the device name in the wireless routing device. In step S320, after an electrical device registers the wireless routing device, a device name corresponding to the remote device is selected and a selection result is generated. In step S330, a wake-up signal is transmitted from the wireless routing device to the remote device according to the selection result. In step S340, the wake-up signal is received by the remote device, and the remote device is switched from a soft-off state to a boot state. In step S350, the wireless routing device may detect whether the remote device has switched to the boot state after the wireless routing device transmitted the wake-up signal. If the remote device has switched to the boot state, the process ends. If the remote device has not switched to the boot state, the wireless routing device may transmit the wake-up signal A2 again after a preset time interval and re-process step S330.

In an embodiment of the disclosure, in the above method, the remote device comprises a first wireless transmission module, and the wireless routing device comprises a second wireless transmission module. In step S310, a pair is established by the first wireless transmission module and the second wireless transmission module. In addition, in step S330 and step S340, the wake-up signal is transmitted from the second wireless transmission module to the first wireless transmission module. When the first wireless transmission module receives the wake-up signal, the first wireless transmission module may generate a trigger signal for switching the remote device from the soft-off state to the boot state. In an embodiment of the disclosure, the first wireless transmission module comprises a receiving unit, and the second wireless transmission module comprises a transmitting unit.

In a wireless transmission environment, traditional remote wake-up technology may not wake up the computer from the soft-off state (S5 state) as defined in ACPI. However, in the remote wake-up method of the disclosure, the remote device in the soft-off state may be woken up by integrating a short-distance transmission function in the network card and the wireless routing device.

The above paragraphs describe many aspects. Obviously, the teaching of the disclosure can be accomplished by many methods, and any specific configurations or functions in the disclosed embodiments only present a representative condition. Those who are skilled in this technology can understand that all of the disclosed aspects in the disclosure can be applied independently or be incorporated.

While the disclosure has been described by way of example and in terms of preferred embodiment, it is to be understood that the disclosure is not limited thereto. Those who are skilled in this technology can still make various alterations and modifications without departing from the scope and spirit of this disclosure. Therefore, the scope of the present disclosure shall be defined and protected by the following claims and their equivalents.

What is claimed is:

1. A remote wake-up system for Wake-On-LAN (WOL) technology, comprising:
an electrical device;
a remote device, including a network card, wherein the remote device is in a soft-off state and the network card includes a first wireless transmission module; and
a wireless routing device, configured to include a second wireless transmission module and establish a pair with the first wireless transmission module by the second wireless transmission module and generate a device name and store the device name in the wireless routing device,
wherein the electrical device generates a selection result by a user selecting the device name corresponding to the remote device after the electrical device registers the wireless routing device, and the wireless routing device transmits a wake-up signal to the first wireless transmission module by the second wireless transmission module according to the selection result, and the first wireless transmission module generates a trigger signal for switching the remote device from the soft-off state to a boot state after receiving the wake-up signal.

2. The remote wake-up system of claim 1, wherein the wireless routing device detects whether the remote device has switched from the soft-off state to the boot state, after the wireless routing device transmits the wake-up signal; and if the wireless routing device does not detect that the remote device has switched from the soft-off state to the boot state, the wireless routing device transmits the wake-up signal again after a preset time interval.

3. The remote wake-up system of claim 1, wherein the first wireless transmission module includes a receiving unit; and the second wireless transmission module includes a transmitting unit, wherein the receiving unit is configured to receive the wake-up signal and the transmitting unit is configured to transmit the wake-up signal.

4. The remote wake-up system of claim 1, wherein the network card includes a LAN chip and a logic gate, wherein the logic gate is connected with the first wireless transmission module and the LAN chip.

5. The remote wake-up system of claim 1, wherein the soft-off state is an S5 state which is defined in Advanced Configuration and Power Interface (ACPI).

6. A remote wake-up method for Wake-On-LAN (WOL) technology, comprising:
establishing a pair between a remote device and a wireless routing device for generating a device name and storing the device name in the wireless routing device;
selecting a device name corresponding to the remote device and generating a selection result after an electrical device registers the wireless routing device;
transmitting a wake-up signal to the remote device by the wireless routing device according to the selection result; and
receiving the wake-up signal by the remote device for switching the remote device from a soft-off state to a boot state.

7. The remote wake-up method of claim 6, wherein the remote device includes a first wireless transmission module, and the wireless routing device includes a second wireless transmission module, and the pair is established by the first wireless transmission module and the second wireless transmission module, wherein a trigger is generated and the remote device is switched from the soft-off state to the boot state after the first wireless transmission module receives the wake-up signal.

8. The remote wake-up method of claim 7, wherein the first wireless transmission module includes a receiving unit; and the second wireless transmission module includes a transmitting unit, wherein the receiving unit is configured to receive the wake-up signal and the transmitting unit is configured to transmit the wake-up signal.

9. The remote wake-up method of claim 6, further comprising:
detecting whether the remote device has switched from the soft-off state to the boot state by the wireless routing device, after the wireless routing device transmits the wake-up signal; if the wireless routing device does not detect that the remote device has switched from the soft-off state to the boot state, the wireless routing device transmits the wake-up signal again after a preset time interval.

10. The remote wake-up method of claim 6, wherein the soft-off state is an S5 state defined in Advanced Configuration and Power Interface (ACPI).
